(19) United States
(12) Patent Application Publication
(10) Pub. No.: US 2023/0199095 A1
(43) Pub. Date: Jun. 22, 2023

(54) SMART PHONE, A TABLET, OR A COMPUTER SCREEN WITH AN INFINITY SCREEN

(71) Applicant: Breon Gilchrist, East Orange, NJ (US)

(72) Inventor: Breon Gilchrist, East Orange, NJ (US)

(21) Appl. No.: 18/082,788

(22) Filed: Dec. 16, 2022

Related U.S. Application Data
(60) Provisional application No. 63/290,123, filed on Dec. 16, 2021.

(51) Int. Cl. H04M 1/02; G02B 30/40; G02B 5/08; G06F 1/16; F21V 33/00

(52) U.S. Cl. CPC H04M 1/0266; G02B 30/40; G02B 5/0816; G06F 1/1637; F21V 33/0052; F21Y 2115/10

(57) ABSTRACT

Disclosed is a smart phone, a computer monitor or a tablet comprising an infinity glass cover. In some embodiments, the phone, computer monitor or tablet further comprises adjustable LED lights, placed inside the phone, computer monitor or tablet.

### TECHNICAL FIELD

This disclosure relates to a smart phone, a tablet, or a computer monitor. Specifically, this disclosure relates to a screen for a smart phone, a tablet or a computer monitor.

### BACKGROUND

Smart phones and tablets, such as iPads, as well as computer monitors, have become part of everyday life. Improvements have been made in almost all aspects of smart phones, tablets and computer monitors. The screen of these devices continues to improve but there is always room for further improvements.

### SUMMARY

In one aspect, this disclosure provides a smart phone, a computer monitor or a tablet comprising an infinity glass screen. In some embodiments, the phone, computer monitor or tablet further comprises adjustable LED lights, placed inside the phone, computer monitor or tablet.

Numerous other aspects are provided in accordance with these and other aspects of the invention. Other features and aspects of the present invention will become more fully apparent from the following detailed description and the appended claims.

### BRIEF DESCRIPTION OF THE DRAWINGS

FIG. 1 is a view of an embodiment of a smart phone with an infinity glass screen. FIG. 2 is a front top view thereof.

### DETAILED DESCRIPTION

As used herein, the word “a” or “plurality” before a noun represents one or more of the particular noun.

For the terms “for example” and “such as,” and grammatical equivalences thereof, the phrase “and without limitation” is understood to follow unless explicitly stated otherwise. As used herein, the term “about” is meant to account for variations due to experimental error. All measurements reported herein are understood to be modified by the term “about,” whether or not the term is explicitly used, unless explicitly stated otherwise. As used herein, the singular forms “a,” “an,” and “the” include plural referents unless the context clearly dictates otherwise.

All ranges disclosed herein are to be understood to encompass any and all subranges subsumed therein. For example, a stated range of “1.0 to 10.0” should be considered to include any and all subranges beginning with a minimum value of 1.0 or more and ending with a maximum value of 10.0 or less, e.g., 1.0 to 5.3, or 4.7 to 10.0, or 3.6 to 7.9.

All ranges disclosed herein are also to be considered to include the end points of the range, unless expressly stated otherwise. For example, a range of “between 5 and 10” or “5 to 10” or “5-10” should be considered to include the end points 5 and 10.

It is further to be understood that the feature or features of one embodiment may generally be applied to other embodiments, even though not specifically described or illustrated in such other embodiments, unless expressly prohibited by this disclosure or the nature of the relevant embodiments. Likewise, compositions and methods described herein can include any combination of features and/or steps described herein not inconsistent with the objectives of the present disclosure. Numerous modifications and/or adaptations of the compositions and methods described herein will be readily apparent to those skilled in the art without departing from the present subject matter.

Unless otherwise defined, all technical and scientific terms used herein have the same meaning as commonly understood by one of ordinary skill in the art to which this invention belongs. Methods and materials are described herein for use in the present invention; other, suitable methods and materials known in the art can also be used. The materials, methods, and examples are illustrative only and not intended to be limiting. All publications, patent applications, patents, sequences, database entries, and other references mentioned herein are incorporated by reference in their entirety. In case of conflict, the present specification, including definitions, will control.

In one aspect, this disclosure provides a smart phone, a computer monitor or a tablet comprising an infinity glass screen. In some embodiments, the phone, computer monitor or tablet further comprises adjustable LED light bulbs, placed inside the phone or tablet.

An infinity glass screen is made of an infinity mirror. An infinity mirror is a configuration of two or more parallel or nearly parallel mirrors, creating a series of smaller and smaller reflections that appear to recede to infinity.

In some embodiments, a plurality of small LED lights are placed inside the phone, computer monitor or tablet, located so as to illuminate the screen when the LED lights are turned on. The LED lights can be turned on and off with a control or an app on the phone or tablet. The LED light bulbs are of suitable size to fit inside the phone or tablet and a suitable number of the light bulbs are placed inside the phone or tablet. An LED light bulb is an electric light that produces light using light-emitting diodes (LEDs).

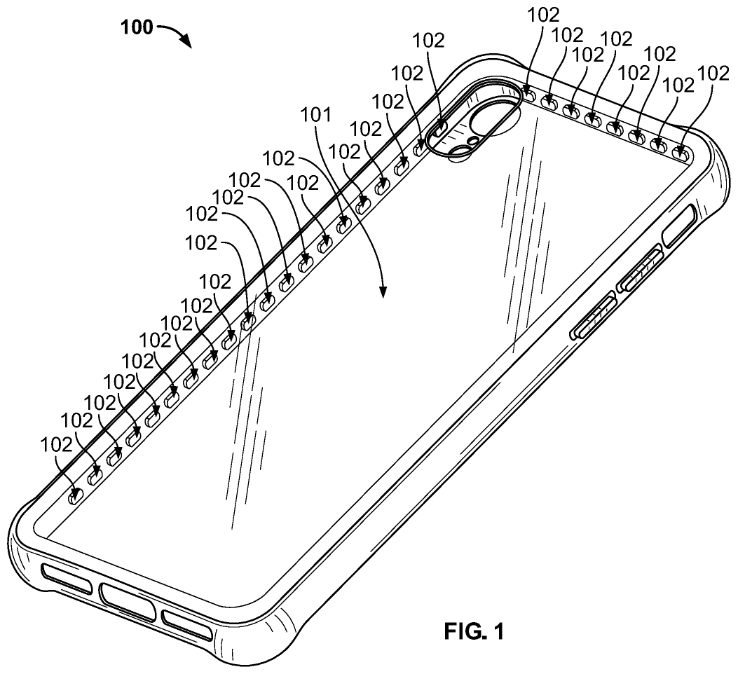

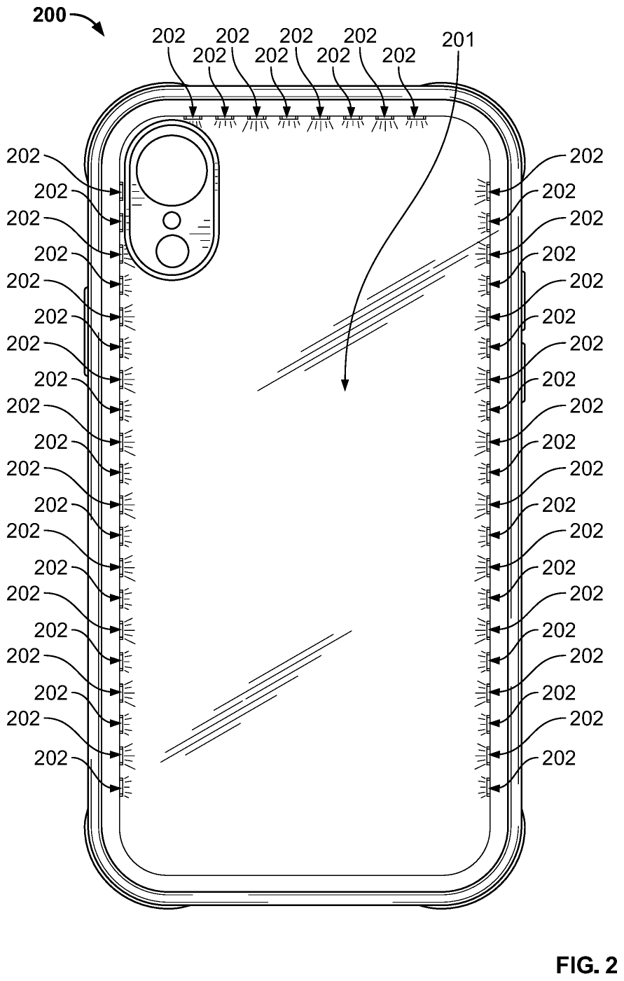

These and other embodiments of the invention are described below with reference to FIGS. 1-2.

An embodiment of a disclosed smart phone 100 is shown in FIG. 1. The phone 100 comprises an infinity glass screen 101 and a plurality of LED lights bulbs 102, with the light bulbs off.

FIG. 2 is another view of the embodiment of FIG. 1. A smart phone 200 is shown in FIG. 2. The phone 200 comprises an infinity glass screen 201 and a plurality of LED lights bulbs 202, with the light bulbs on.

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the appended claims. Thus, while only certain features of the invention have been illustrated and described, many modifications and changes will occur to those skilled in the art. It is therefore to be understood that the appended claims are intended to cover all such modifications and changes as fall within the true spirit of the invention.

What is claimed is:

1. A smart phone comprising an infinity glass screen.

2. The phone of claim 1, further comprising adjustable LED light bulbs, placed inside the phone.

3. A computer monitor comprising an infinity glass screen.

4. The computer monitor of claim 3, further comprising adjustable LED light bulbs, placed inside the computer monitor.

5. A tablet comprising an infinity glass screen.

6. The tablet of claim 5, further comprising adjustable LED light bulbs, placed inside the tablet.
